(19) United States
(12) Patent Application Publication
(10) Pub. No.: US 2019/0293109 A1
(43) Pub. Date: Sep. 26, 2019

(54) LOCKOUT DEVICE AND A METHOD FOR ITS USE

(71) Applicant: David Johnson, Brooksville, FL (US)

(72) Inventor: David Johnson, Brooksville, FL (US)

(21) Appl. No.: 16/140,412

(22) Filed: Sep. 24, 2018

Related U.S. Application Data
(60) Provisional application No. 62/562,425, filed on Sep. 23, 2017.

(51) Int. Cl. F16B 41/00; F16L 23/00; E05B 65/48

(52) U.S. Cl. CPC F16B 41/005; F16L 55/10; E05B 65/48; F16L 23/003

(57) ABSTRACT

The present lockout device is designed for use with connections secured by a combination nut and bolt fastener such as those found in piping connections, and particularly piping connections where a blind flange has been installed. Specifically, the present lockout device can comprise a bar section comprising a male locking bar and a clamp section configured to be securely, but removably connected to the male locking bar. In particular, the clamp section can be configured to remain securely connected to the male locking bar until a padlock or other similar locking device has been removed from it.

### CROSS REFERENCE TO RELATED APPLICATIONS

This Application claims benefit to provisional application No. 62/562,425, which is incorporated by reference herein in its entirety.

### FIELD OF THE INVENTION

The present apparatus is an improved design for a lockout device for use with blind flanges and similar devices that are secured together by one or more combination bolt and nut fasteners.

### BACKGROUND

A blind flange is an object used to close off piping systems thus preventing liquids or gasses from passing through the piping system. Typically, a blind flange is a plate having bolt holes matching those in the piping but no hole in the center. Therefore, the solid center of the blind flange prevents liquids or gasses from passing through the piping systems onto which it is installed.

Blind flanges are used for many purposes, but one of the primary purposes is to block the flow of liquids or gasses when a piping system is being cleaned or repaired. Therefore, it is extremely important that a blind flange not accidentally be removed while work is being performed on a piping system. In some circumstances, doing so could result in injury or death to those working on the piping system.

Lockout devices have been invented to prevent many types of industrial accidents. Such devices typically work by preventing switches from being flipped or valves from being opened or closed by covering or otherwise disabling the switch or valve and then locking the device with a padlock or similar locking mechanism, that can lock the lockout device into place by a user. Therefore, safety is achieved because one or more users of the lockout device can single-handedly prevent an operation, such as turning on a switch or opening a valve until the user or users of the lockout devices allow it. As a blind flange works as a type of valve, closing off flow of such liquids or gases within a pipe, its unauthorized or accidental removal can cause injury or death to people depending on it to stop the flow of liquids or gases. Therefore, a lockout device that is designed to quickly and effectively prevent its unauthorized or accidental removal could be used to prevent such injuries or deaths.

What is needed is a lockout device that can prevent a blind flange from being removed from a piping system when the lockout device is locked onto one or more bolts securing the blind flange in place.

### SUMMARY OF THE INVENTION

It is an aspect of the present inventive concept to provide a lockout device for use with blind flanges and similar objects.

The above aspects can be obtained by a lockout device comprising: a bar section having an male locking bar with a first end and second end and a smooth top edge and a serrated bottom edge having two or more teeth of a particular size, shape and particular spacing between each, wherein the first end is fixedly connected to a bar section protective cup located below the serrated bottom edge, wherein the bar section protective cup comprises an open section, a closed end and an open end, wherein the closed end is nearest the first end of the male locking bar and the open section is closest to the second end of the male locking bar; and a clamp section having a female locking hasp having a first end and a second end and a male locking hasp having a first end and a second end, wherein the first end of the female locking hasp is hingedly connected to the first end of the male locking hasp allowing the clamp section to be moved between an open configuration and a closed configuration, and wherein the second end of the female locking hasp and the second end of the male locking hasp form a clamp section protective cup when the clamp section is moved into a closed configuration, and wherein the clamp section protective cup comprises an open section, a closed end and an open end.

The above aspects can also be obtained by a lockout device comprising lockout device comprising a bar section having an male locking bar with a first end and second end and a smooth top edge and a serrated bottom edge having two or more teeth of a particular size, shape and particular spacing between each, wherein the first end is fixedly connected to a bar section protective cup located below the serrated bottom edge, wherein the bar section protective cup comprises an open section, a closed end and an open end, wherein the closed end is nearest the first end of the male locking bar and the open section is closest to the second end of the male locking bar, a clamp section having a female locking hasp having a first end and a second end and a first locking hasp plate comprising a first bar opening and a second locking hasp plate comprising a second bar opening, and a male locking hasp having a first end and a second end, wherein the first end of the female locking hasp is hingedly connected to the first end of the male locking hasp allowing the clamp section to be moved between an open configuration and a closed configuration, and wherein the second end of the female locking hasp and the second end of the male locking hasp form a clamp section protective cup when the clamp section is moved into a closed configuration, and wherein the clamp section protective cup comprises an open section, a closed end and an open end.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a top and side perspective view of a present lockout device, in a closed configuration, installed on a piping connection, comprising a blind flange and locked into position by the use of a padlock, according to an embodiment;

FIG. 2 is a top and side perspective and exploded view of a clamp section comprising the present lockout device, according to an embodiment;

FIG. 3 is a top and side perspective and partially exploded view of the bar section and the clamp section, in an open configuration, comprising the present lockout device shown in close proximity to a piping connection shown in a partial view, according to an embodiment;

FIG. 4 is a side cutaway view of the present lockout device, with the clamp section in a closed configuration, installed on a piping connection as originally shown in FIG. 1, according to an embodiment;

FIG. 5 is a top and side perspective and exploded view of the clamp section comprising the present lockout device, according to an alternative embodiment; and

FIG. 6 is a top and side perspective and exploded view of the clamp section comprising the present lockout device, according to an alternative embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The present lock out device functions by covering each end of at least one combination bolt and nut fastener securing a blind flange, or similar apparatus, in place thus preventing access to the bolt and nut by a wrench, socket or similar device, which could be used to remove it. In order to function properly, the lockout device can have the ability to adjust to bolts and nuts of varying dimensions that are separated by a certain range of distances. Once adjusted to a selected position of appropriate length to cover each end of the bolt and nut combination, the present lockout device must be able to be locked into this selected position by the attachment of a padlock or similar locking device. Also, the present lockout device must be made from a material that is strong enough that it cannot be easily broken or bent and removed from its position over the bolt and nut and it must also be configured such that it will not fall off of the combination bolt and nut fastener upon which it has been connected.

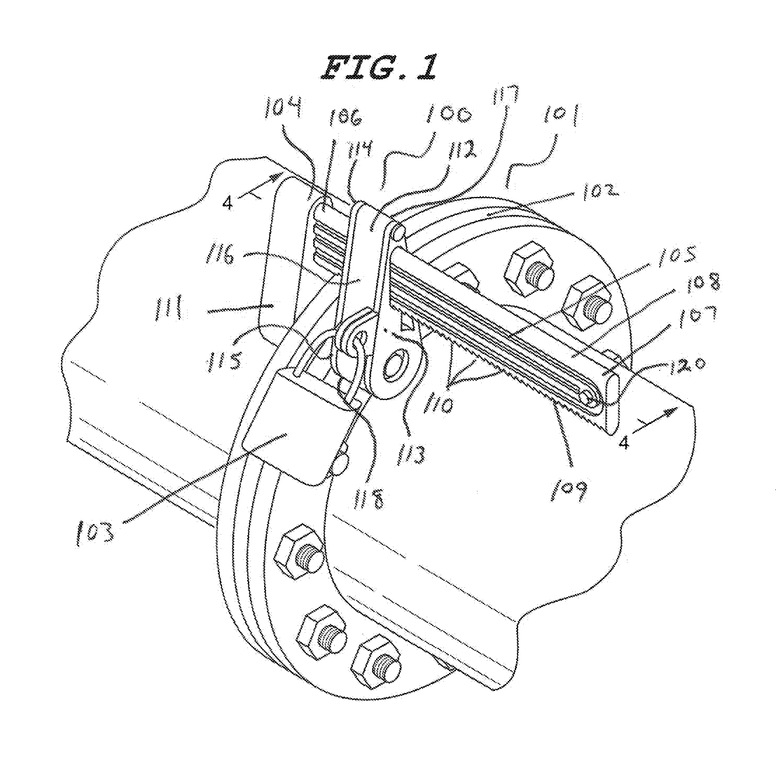

FIG. 1 is a top and side perspective view of the present lockout device 100 installed on a piping connection 101, comprising a blind flange 102, and locked into position by the use of a padlock 103, according to an embodiment. The present locking device 100 can comprise a bar section 104 having an male locking bar 105 with a first end 106 and second end 107 and a smooth top edge 108 and a serrated bottom edge 109 comprising two or more teeth 110 of a particular size, shape and a particular spacing between each, wherein the first end 106 of the bar section 104 is fixedly connected to a bar section protective cup 111 located below the serrated bottom edge 109 of the male locking bar 105. The bar section protective cup 111 can comprise an open section, a closed end and an open end, wherein the closed end is nearest the first end of the male locking bar and the open section is closest to the second end of the male locking bar 105 (not visible in FIG. 1). The present locking device 100 can also comprise a clamp section 112. The clamp section 112 can comprise a female locking hasp 113 having a first end 114 and a second end 115 and a male locking hasp 116 having a first end 117 and a second end 118, wherein the first end 114 of the female locking hasp 113 can be hingedly connected to the first end 117 of the male locking hasp 116 allowing the clamp section 112 to be moved between an open configuration (not shown in FIG. 1) and a closed configuration (as shown in FIG. 1), and wherein the second end 115 of the female locking hasp 114 and the second end 118 of the male locking hasp 116 can form a clamp section protective cup (not visible in FIG. 1) when the clamp section 112 is moved into a closed configuration as shown in FIG. 1. According to an embodiment, the male locking bar 105 can comprise a stop pin 120 near its second end 107. This stop pin can be used to retain the clamp section 112 onto the male locking bar 105 of the bar section 104.

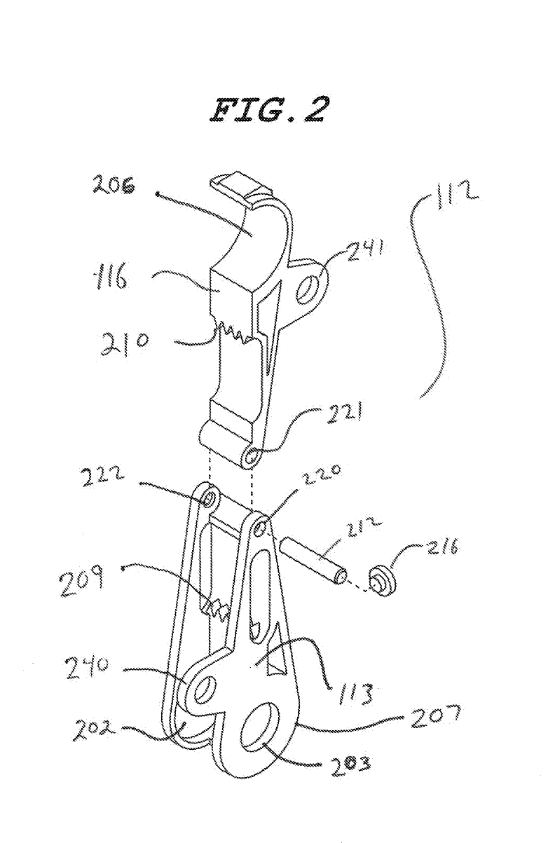

FIG. 2 is a top and side perspective and exploded view of the clamp section 112 comprising the present lockout device 100, according to an embodiment. This view clearly depicts the parts comprising the clamp section 112, according to an embodiment, namely, the female locking hasp 113, the male locking hasp 116 and the hinge pin 212 used to create the hinged connection of the female locking hasp 112 to the male locking hasp 116. According to an embodiment, the hinge pin 212 can be secured in place by a hinge pin cap 216.

According to an embodiment, the female locking hasp 113 and the male locking hasp 116 can form a clamp section protective cup when the two sides are moved into a closed configuration. In an embodiment, this clamp section protective cup can comprise a large opening 202 near on one side of the second end 115 of the female locking hasp 113 and a small opening 203 near the opposite side of the second end 115 of the female locking hasp 113. According to an embodiment, the large opening 202 can be configured to allow both a nut (not shown if FIG. 2) and a bolt end (also not shown in FIG. 2) to pass through it, but the small opening 203 can allow the bolt end to pass through it, but not the nut, thus denying access to the nut.

The second end 118 of the male locking hasp 116 can comprise a first curved section 206 and the second end 115 of the female locking hasp 113 can comprise a second curved section 207 configured such that when the clamp section 112 in placed in the closed configuration, the first curved section 206 and the second curved section 207 create the cylindrical walls of the clamp section protective cup, which can be of sufficient size and shape to at least partially surround and enclose at least one nut, thus preventing access to it.

In an embodiment, either the female locking hasp 113 and the male locking hasp 116 can comprise a set of serrated teeth, each comprising two or more teeth of a particular size, shape and particular spacing between each allowing these teeth to interconnect with the serrated teeth 110 of the bar section 104 when the clamp section 112 is in its closed configuration. Specifically, and as show in FIG. 2, the female locking hasp 113 can comprise a set of female locking hasp teeth 209 and the male locking hasp 116 can comprise a set of male locking hasp teeth 210. According to an embodiment, when the second end 118 of the male locking hasp 116 can be positioned near the which can wrap around the nut and bolt when the clamp section 112 is in the closed configuration. In an embodiment, when either the set of female locking hasp teeth 209, the set of male locking hasp teeth 210, or both interconnect with the serrated teeth 110 of the bar section 104, the clamp section 112 is prevented from being able to move laterally in either direction along the male locking bar 105.

FIG. 2 also depicts how the hinged connection of the female locking hasp 113 can be made to the male locking hasp 116, according to an embodiment. Specifically, the hinge pin 212 can be inserted through a first hinge pin receiving hole 220 located at the first end 114 of the female locking hasp 113, then through the middle hinge pin receiving hole 221 located at the first end 117 of the male locking hasp 116, and finally through the second hinge pin receiving hole 222 located on the first end 114 of the female locking hasp 113, on the side opposite the first hinge pin receiving hole 220. In an embodiment, the second hinge pin receiving hole 222 can be a recessed cup-like structure having only one opening thus preventing the hinge pin 212 from passing through it entirely.

According to an embodiment, the female locking hasp 113 can comprise a first padlock loop 240 and the male locking hasp 116 can comprise a second padlock loop 241, each configured such that the two align when the clamp section 112 is placed in a closed configuration to allow a padlock or similar device to prevent the female locking hasp 113 and the male locking hasp 116 from rotating about the hinged connection as shown in FIG. 1.

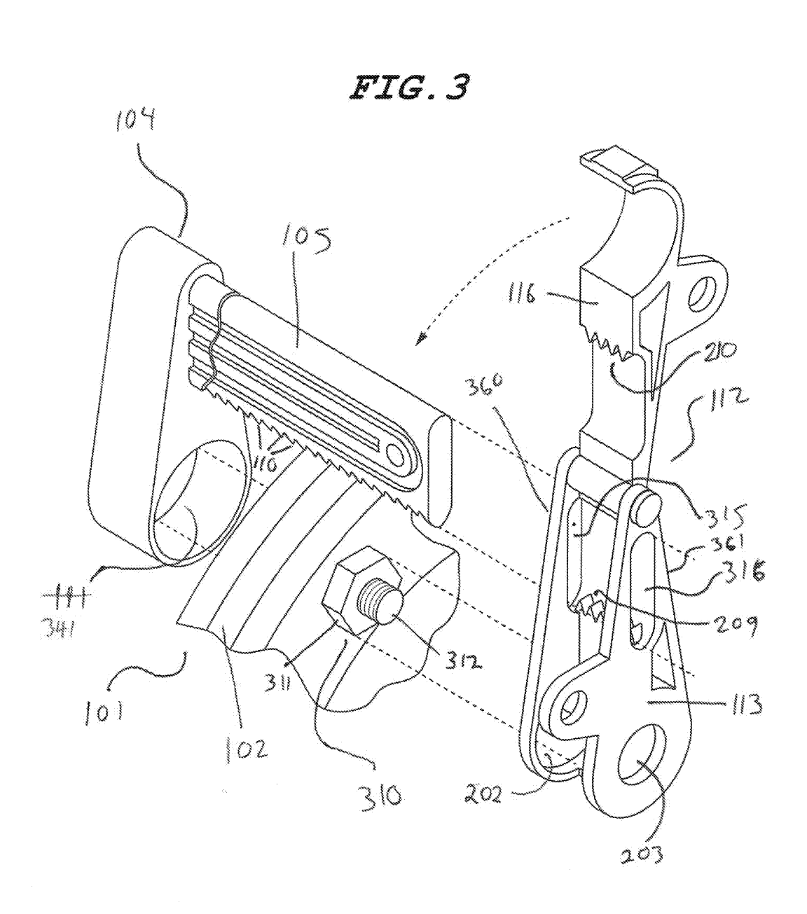

FIG. 3 is a top and side perspective and partially exploded view of the bar section 104 and the clamp section 112 comprising the present lockout device 100 shown in close proximity to a piping connection 101 comprising a blind flange 102, which is shown in a partial view, according to an embodiment. This view depicts how the parts of the present lockout device 100 can be installed on a piping connection 101, according to an embodiment. Specifically, the bar section 104 can be placed such that the bar section protective cup 341 can cover a first side (not visible in FIG. 3) of a combination bolt and nut fastener 310, comprising a nut 311 and a bolt 312 (only the bolt end is visible in FIG. 3) while the male locking bar 105 runs parallel to the bolt 312 and perpendicular to the blind flange 102, according to an embodiment.

The clamp section 112 can then be slid onto the male locking bar 105 by placing the second end 107 of the male locking bar 105 through a first male locking bar opening 315 located on a first side 360 of the female locking hasp 113 and then through a second male locking bar opening 316 located on a second side 361 of the female locking hasp 113, according to an embodiment. In this way the clamp section 112 can be slid laterally down the male locking bar until the nut 311 and bolt 312 pass through the large opening 202 and into the clamp section protective cup, according to an embodiment. In an embodiment, the bolt 312 can then pass through the small opening 203 if necessary to allow the clamp section 112 to be located securely against the piping connection 101.

According to an embodiment, the clamp section 112 can then be securely connected to a chosen point along the male locking bar 105 by rotating the male locking hasp 116 from an open configuration as shown in FIG. 3, to a closed configuration, such as that shown in FIG. 1. The secure connection of the clamp section 112 to the male locking bar 205 can be made by engaging either the set of female locking hasp teeth 209, the set of male locking hasp teeth 210, or both to the serrated teeth 110 of the bar section 104.

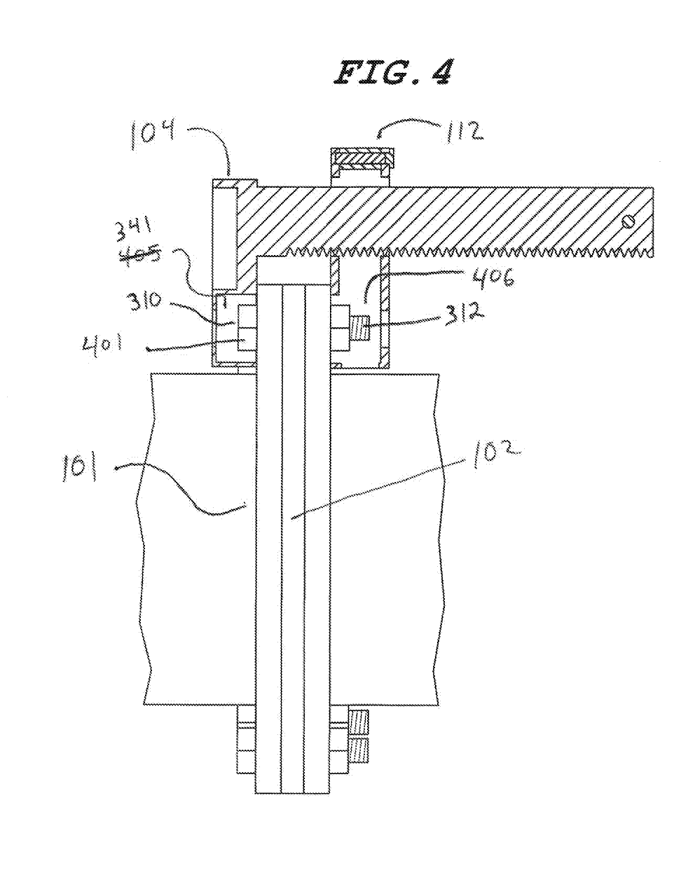

FIG. 4 is a side cutaway view of the present lockout device 100 installed on a piping connection 101, as previously shown in FIG. 1, according to an embodiment. This view clearly depicts the relative positions of the bar section 104 to the clamp section 112, and to the relative position of the present lockout device 100 to the piping connection 101 and the blind flange 102, according to an embodiment. This view also shown both ends of the combination bolt and nut fastener 310, including the first end 401 of the bolt 312 and the nut 311 connected to the bolt 312. According to an embodiment, the bar section protective cup 341 can prevent access to the first end 401 of the bolt 312 and the clamp section protective cup 406 can prevent access to the nut 311. As all combination bolt and nut fasteners 310, or similar fastening devices, must typically be removed in order to remove the blind flange 102, the present lockout device 100 can prevent the unauthorized or accidental removal of the blind flange 102.

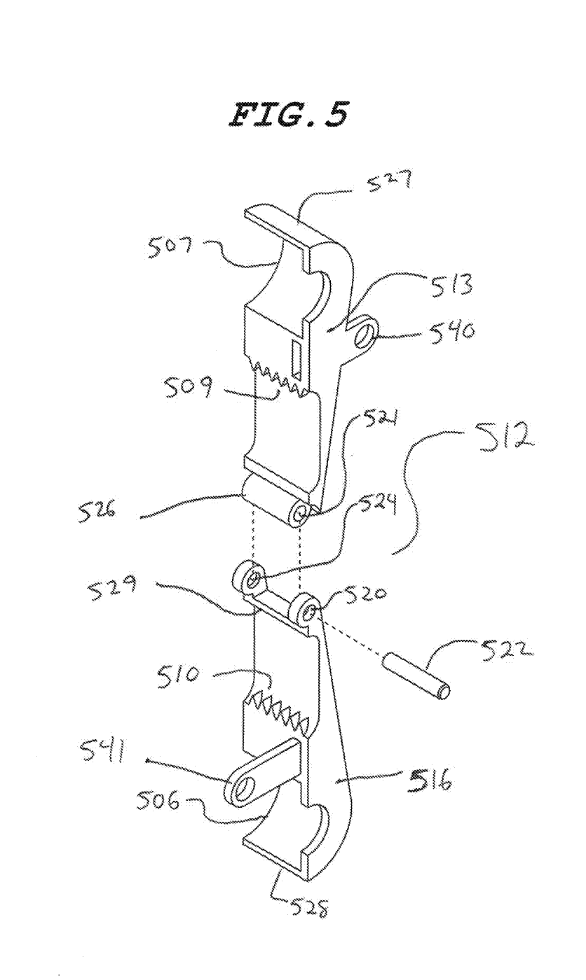

FIG. 5 is a top and side perspective and exploded view of the clamp section 512 comprising the present lockout device 100, according to an alternative embodiment. In this embodiment, there is no male locking hasp or female locking hasp as described above. Rather, the clamp section 512 is comprises a first locking hasp 513 having a first end 526 and a second end 527, which abuts a second locking hasp 516 having a first end 529 and a second end 528 when the clamp section 512 is placed into a closed configuration. This view clearly depicts the parts comprising the clamp section 512, according to an embodiment, namely, the first locking hasp 513, the second locking hasp 516 and the hinge pin 522 used to create the hinged connection of the first end 526 of the first locking hasp 513 to the first end 529 of the second locking hasp 516.

According to an embodiment, the first locking hasp 513 and the second locking hasp 516 can form a clamp section protective cup (similar to 406 discussed above) when the two are moved into a closed configuration. In an embodiment, this clamp section protective cup can comprise a large opening near one side of the clamp section protective cup and a small opening near the opposite side of the clamp section protective cup. According to an embodiment, the large opening can be configured to allow both a nut (not shown if FIG. 5) and a bolt end (also not shown in FIG. 5) to pass through it, but the small opening can allow the bolt end to pass through it, but not the nut, thus denying access to the nut.

The second end 528 of the second locking hasp 516 can comprise a first curved section 506 and the second end 527 of the first locking hasp 513 can comprise a second curved section 507 configured such that when the clamp section 512 in placed in the closed configuration, the first curved section 506 and the second curved section 507 create the cylindrical walls of the clamp section protective cup, which can be of sufficient size and shape to at least partially surround and enclose at least one nut, thus preventing access to it.

In an embodiment, either the first locking hasp 513 and the second locking hasp 516 can comprise a set of serrated teeth, each comprising two or more teeth of a particular size, shape and particular spacing between each allowing these teeth to interconnect with the serrated teeth 110 of the bar section 104 when the clamp section 512 is in its closed configuration. Specifically, the first locking hasp 513 can comprise a set of first locking hasp teeth 509 and the second locking hasp 516 can comprise a set of second locking hasp teeth 510. According to an embodiment, when the second end 528 of the second locking hasp 516 can be positioned near the second end 527 of the first locking hasp 513, the clamp section protective cup, which can at least partially wrap around the nut and bolt when the clamp section 112 is in the closed configuration. In an embodiment, when either the set of first locking hasp teeth 509, the set of second locking hasp teeth 510, or both interconnect with the serrated teeth 110 of the male locking bar 105, the clamp section 512 can be prevented from being able to move laterally in either direction along the bar section 104.

FIG. 5 also depicts how the hinged connection of the first locking hasp 513 can be made to the second locking hasp 516, according to an embodiment. Specifically, the hinge pin 522 can be inserted through a first hinge pin receiving hole 520 located at the first end 529 of the second locking hasp 516, then through the middle hinge pin receiving hole 521 located at the first end 526 of the first locking hasp 513, and finally through the second hinge pin receiving hole 524 located on the first end 529 of the second locking hasp 516, on the side opposite the first hinge pin receiving hole 520. In an embodiment, the second hinge pin receiving hole 524 can be a recessed cup-like structure having only one opening thus preventing the hinge pin 522 from passing through it entirely.

According to an embodiment, the first locking hasp 513 can comprise a first padlock loop 540 and the second locking hasp 516 can comprise a second padlock loop 541, each configured such that the two align when the clamp section 512 is placed in a closed configuration to allow a padlock or similar device to prevent the first locking hasp 513 and the second locking hasp 516 from rotating about the hinged connection.

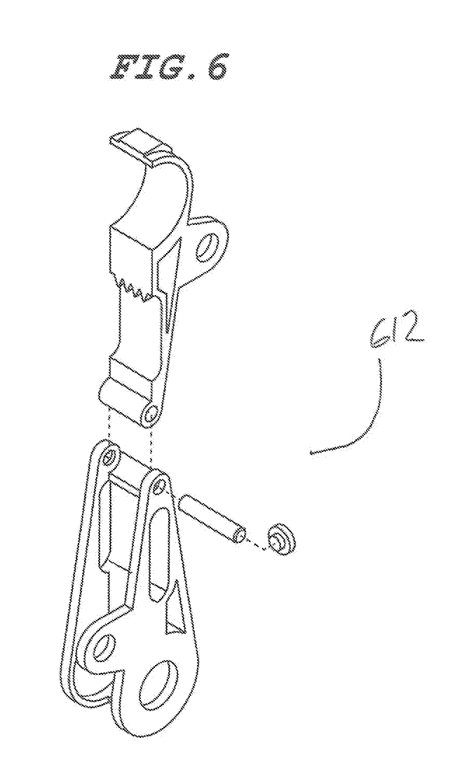

FIG. 6 is a top and side perspective and exploded view of the clamp section 612 comprising the present lockout device, according to an alternative embodiment. This embodiment is identical to clamp section 112 except the female locking hasp teeth 209 have been removed to allow the male locking bar 105 to pass more easily through the first male locking bar opening 315 and second male locking bar opening 316.

The present device can be comprised of metal, wood, or plastic, but has been designed to function optimally if the parts are comprised of plastic, polycarbonate, or a similar polymeric material.

Although the present apparatus has been described in terms of exemplary embodiments, it is not limited thereto. Rather, the appended claims should be construed broadly, to include other variants and embodiments, which may be made by those skilled in the art without departing from the scope and range of equivalents of the disclosed apparatus. All features and embodiments described herein (including documents incorporated by reference) can be combined with each other without limitation.

What is claimed is:

1. A lockout device comprising:
a bar section having an male locking bar with a first end and second end and a smooth top edge and a serrated bottom edge having two or more teeth of a particular size, shape and a particular spacing between each, wherein the first end is fixedly connected to a bar section protective cup located below the serrated bottom edge, wherein the bar section protective cup comprises an open section, a closed end and an open end, wherein the closed end is nearest the first end of the male locking bar and the open section is closest to the second end of the male locking bar; and
a clamp section having a female locking hasp having a first end and a second end and a male locking hasp having a first end and a second end, wherein the first end of the female locking hasp is hingedly connected to the first end of the male locking hasp allowing the clamp section to be moved between an open configuration and a closed configuration, and wherein the second end of the female locking hasp and the second end of the male locking hasp form a clamp section protective cup when the clamp section is moved into a closed configuration, and wherein the clamp section protective cup comprises an open section, a closed end and an open end.

2. The lockout device described in claim 1 wherein the female locking hasp comprises a serrated edge having two or more teeth of the particular size, shape and the particular spacing between each matching the serrated bottom edge of the bar section.

3. The lockout device described in claim 2 wherein the male locking hasp comprises a serrated edge having two or more teeth of the particular size, shape and the particular spacing between each matching the serrated bottom edge of the bar section and the serrated edge of the first clamping part.

4. The lockout device described in claim 3 wherein the serrated teeth of the first clamping section and the serrated teeth of the second clamping section each interlock with the serrated edge of the bar section when the clamping section is placed in the closed configuration, over the bar section wherein the hinged connection of the first end of the female locking hasp and the first end of the male locking hasp are closest to the smooth top edge of the bar section and the clamp section protective cup is closest to the serrated bottom edge of the bar section.

5. The lockout device described in claim 4 wherein the open end of the bar section protective cup and the open end of the clamp section protective cup are facing each other when the clamping section is placed in the closed configuration over the bar section wherein the hinged connection of the first end of the female locking hasp and the first end of the male locking hasp are closest to the smooth top edge of the bar section and the clamp section protective cup is closest to the serrated bottom edge of the bar section.

6. The lockout device described in claim 1 wherein the female locking hasp comprises a first lock loop having a first lock loop hole and the male locking hasp comprises a second lock loop having a second lock loop hole, wherein the first lock loop hole and the second lock loop hole align to create a combined lock loop opening when the clamp section is moved into the closed configuration.

7. The lockout device described in claim 1 wherein the closed end of the bar section protective cup comprises an opening to allow a bolt to pass through it and the closed end of the clamp section protective cup comprises an opening to allow a bolt to pass through it.

8. The lockout device described in claim 2 wherein the female locking hasp comprises:
a first locking hasp plate having a first end and a second end wherein the first end of the first locking hasp plate comprises a hinge rod receiving hole and the second end of the first hasp locking plate comprises the open end of the clamp section protective cup;
a second locking hasp plate having a first end and a second end wherein the first end of the second locking hasp plate comprises a hinge rod receiving hole and the second end of the second hasp locking plate comprises the closed end of the clamp section protective cup; and
a rear locking hasp plate having a first side, a second side, a top and a bottom, wherein the first side of the rear locking hasp plate is connected to the first locking hasp plate, the second side of the rear locking hasp plate is connected to the second locking hasp plate, and the top comprises the serrated edge having two or more teeth of the particular size, shape and the particular spacing between each matching the serrated bottom edge of the bar section.

9. The lockout device described in claim 8 wherein the second locking hasp plate comprises a first lock loop.

10. The lockout device described in claim 8 wherein the second side of the first locking hasp plate comprises a first lock loop

11. The lockout device described in claim 1 wherein the male locking hasp comprises a rear locking hasp plate configured to fit between the first locking hasp plate and the second locking hasp plate of female locking hasp, the male locking hasp having a first side, a second side, a top and a bottom, wherein the top comprises a hinge loop and the bottom comprises a male section of the clamp section protective cup, and wherein a serrated edge having two or more teeth of the particular size, shape and the particular spacing between each matching the serrated bottom edge of the bar section is located between the top and the bottom of the rear locking hasp plate.

12. The lockout device described in claim 1 wherein the hinged connection of the female locking hasp to the male locking hasp is created by a hinge pin which connects the hinge pin receiving hole of the first locking hasp plate to the hinge pin receiving hole of the first locking hasp plate while also passing through the hinge loop of the male locking hasp.

13. The lockout device described in claim 12 wherein the hinge pin is secured in place with a hinge pin cap.

14. The lockout device described in claim 1 wherein the second end of the male locking bar comprising the male locking bar comprises a stopping pin.

15. The lockout device described in claim 11 wherein the second side of the male locking hasp comprises a first lock loop.

16. The lockout device described in claim 11 wherein the first side of the male locking hasp comprises a first lock loop.

17. The lockout device described in claim 1 wherein the parts of the lockout device are comprised of polycarbonate.

18. A lockout device comprising:
a bar section having an male locking bar with a first end and second end and a smooth top edge and a serrated bottom edge having two or more teeth of a particular size, shape and particular spacing between each, wherein the first end is fixedly connected to a bar section protective cup located below the serrated bottom edge, wherein the bar section protective cup comprises an open section, a closed end and an open end, wherein the closed end is nearest the first end of the male locking bar and the open section is closest to the second end of the male locking bar;
a clamp section having a female locking hasp having a first end and a second end and a first locking hasp plate comprising a first bar opening and a second locking hasp plate comprising a second bar opening; and
a male locking hasp having a first end and a second end, wherein the first end of the female locking hasp is hingedly connected to the first end of the male locking hasp allowing the clamp section to be moved between an open configuration and a closed configuration, and wherein the second end of the female locking hasp and the second end of the male locking hasp form a clamp section protective cup when the clamp section is moved into a closed configuration, and wherein the clamp section protective cup comprises an open section, a closed end and an open end.

19. The lockout device described in claim 1 wherein the second end of the male locking bar comprises a stop pin.

20. The lockout device described in claim 1 wherein the components are made of a polymeric material.
